(19) United States
(12) Patent Application Publication
(10) Pub. No.: US 2025/0142028 A1
(43) Pub. Date: May 1, 2025

(54) OVERLAPPING IMAGE FIELD UPDATES IN A DISPLAY SYSTEM

(71) Applicant: GOOGLE LLC, Mountain View, CA (US)

(72) Inventors: Edwin Lyle Hudson, San Jose, CA (US); Robert Lo, San Jose, CA (US); Jeffrey Tang Fung Li, Palo Alto, CA (US); Stuart James Myron Nicholson, San Jose, CA (US)

(21) Appl. No.: 18/932,142

(22) Filed: Oct. 30, 2024

Related U.S. Application Data
(60) Provisional application No. 63/594,817, filed on Oct. 31, 2023.

(51) Int. Cl. H04N 9/31; G06F 3/147

(52) U.S. Cl. CPC H04N 9/3123; G06F 3/147

(57) ABSTRACT

An illustrative display system includes an array of pixels and a frame controller configured to cause the array of pixels to display an image frame by performing a series of successive field updates. The series of successive field updates includes a first field update in which a first write pointer circuit tracks a first traversal, during a first update period, across the array of pixels to update the array of pixels from a first to a second image field in the sequence, and a second field update in which a second write pointer circuit tracks a second traversal, during a second update period, across the array of pixels to update the array of pixels from the second to a third image field in the sequence. The second update period of the second field update overlaps the first update period of the first field update.

### RELATED APPLICATIONS

This application claims priority to and the benefit of U.S. Provisional Application No. 63/594,817, filed on Oct. 31, 2023, the disclosure of which is hereby incorporated by reference in its entirety.

### BACKGROUND

Digitally-encoded images may be presented to viewers using a variety of different types of image displays featured in a variety of different types of devices. For example, personal computing devices (e.g., laptops, tablets, etc.), mobile devices (e.g., smartphones, electronic readers, etc.), wearable devices (e.g., smartwatches, etc.), extended reality devices (e.g., virtual and augmented reality headsets), televisions, and various other devices all may feature image displays configured to present images to users of the devices.

### SUMMARY

Certain display systems operate using pulse-width modulation (PWM) of pixel emission to control brightness of the pixels and, by controlling relative brightness of different primary colors in each pixel (e.g., red, green, and blue), also controlling the color emitted by the pixels. For example, certain micro light emitting diode (microLED) displays may operate using these principles. To achieve different brightness levels, frame controllers described herein may direct an array of pixels to display an image frame by performing a series of successive field updates, each of which takes a finite amount of time (referred to herein as an update period) as a write pointer traverses the array and changes each pixel from one image field to the next. To maximize dynamic range (e.g., to allow for pixels to appear very dim while not being completely off), it is desirable to have some image fields displayed for periods of time (referred to herein as field durations) that are shorter than a minimum panel update period of a given display system. Accordingly, systems and methods described herein allow for extremely short field durations (and, consequently, for very high dynamic range and flexibility of how field sequences may be configured) by employing multiple write pointers to allow image field updates to overlap (i.e., to occur concurrently).

To this end, one implementation described herein involves a display system configured in accordance with principles described herein. The display system may include an array of pixels and a frame controller configured to cause the array of pixels to display an image frame by performing a series of successive field updates. The series of successive field updates may include: 1) a first field update in which a first write pointer circuit tracks a first traversal, during a first update period, across the array of pixels to update the array of pixels from a first image field of an image field sequence to a second image field of the image field sequence, and 2) a second field update in which a second write pointer circuit tracks a second traversal, during a second update period, across the array of pixels to update the array of pixels from the second image field to a third image field of the image field sequence. In this display system, the second update period of the second field update may overlap the first update period of the first field update.

Other implementations described herein may involve a method that is performed by a display system such as described above. The method may include operations such as causing, by the display system, an array of pixels to display an image frame by performing a series of successive field updates. The series of successive field updates may include: 1) a first field update in which a first write pointer circuit tracks a first traversal, during a first update period, across the array of pixels to update the array of pixels from a first image field of an image field sequence to a second image field of the image field sequence, and 2) a second field update in which a second write pointer circuit tracks a second traversal, during a second update period, across the array of pixels to update the array of pixels from the second image field to a third image field of the image field sequence. In this method, the second update period of the second field update may overlap the first update period of the first field update.

Still other implementations described herein may involve a non-transitory computer-readable medium storing instructions that, when executed, cause a frame controller of a display system to perform a process. For example, the process may include causing an array of pixels to display an image frame by performing a series of successive field updates. The series of successive field updates may include: 1) a first field update in which a first write pointer circuit tracks a first traversal, during a first update period, across the array of pixels to update the array of pixels from a first image field of an image field sequence to a second image field of the image field sequence, and 2) a second field update in which a second write pointer circuit tracks a second traversal, during a second update period, across the array of pixels to update the array of pixels from the second image field to a third image field of the image field sequence. In this process, the second update period of the second field update may overlap the first update period of the first field update.

Various additional implementations are explicitly described herein or may follow from principles described below. It will be understood that each of the examples mentioned above and described below may be implemented in different types of implementations. For example, the various display systems described herein could each be implemented in a variety of different types of devices, methods described herein could be implemented by instructions stored in a non-transitory computer-readable medium, a non-transitory computer-readable medium storing such instructions could be implemented in a display system, or the like.

The details of these and other implementations are set forth in the accompanying drawings and the description below. Other features will also be made apparent from the following description, drawings, and claims.

### BRIEF DESCRIPTION OF THE DRAWINGS

FIG. 1 shows certain aspects of an illustrative implementation of overlapping image field updates in a display system in accordance with principles described herein.

FIG. 2 shows a block diagram of an illustrative display system configured to implement overlapping image field updates in accordance with principles described herein.

FIG. 3 shows a block diagram illustrating certain aspects of how a sequencer circuit may operate to achieve overlapping image field updates in a display system in accordance with principles described herein.

FIG. 4 shows an illustrative method for performing overlapping image field updates in a display system in accordance with principles described herein.

FIG. 5 shows certain aspects of how an illustrative display system may perform overlapping image field updates to present image frames based on image field sequence data in accordance with principles described herein.

FIG. 6 shows certain timing-related aspects of an implementation of overlapping image field updates in a display system in accordance with principles described herein.

FIG. 7 shows additional aspects of an implementation of overlapping image field updates in a display system in accordance with principles described herein.

FIG. 8 shows an illustrative device in which a display system configured to perform overlapping image field updates may be implemented in accordance with principles described herein.

FIG. 9 shows an illustrative computing system that may be used to implement various devices and/or systems described herein.

### DETAILED DESCRIPTION

Systems and methods implementing overlapping image field updates in a display system are described herein. As used herein, an array of pixels refers to pixels included on a panel of an image display such as may be included in various types of electronic devices (e.g., extended reality headsets, mobile devices, smartwatches, computer monitors, televisions, etc.). One multi-color pixel may be implemented as a composite of at least three pixel elements, such as a red pixel element, a green pixel element, and a blue pixel element. In combination, these three primary colors may be used to generate not only pure red, green, and blue light, but also white light and many other colors. In some examples, other color schemes may be used other than this red, green, and blue (RGB) color scheme. As used herein, the pixels included in an array of pixels may refer to the composite RGB pixels and/or to the individual pixel elements (e.g., the red pixel element of a given composite pixel, the green pixel element of the composite pixel, etc.) of such composite pixels.

An array of pixels may display an image when the pixels are driven at different brightness levels in accordance with the content of the image. For example, if there is relatively bright red content in a portion of an image, red pixels (i.e., the red pixel elements of composite pixels) in a region of the display associated with that content may be driven at a high intensity (so as to have a high brightness) while other pixels in that region (e.g., blue and green pixels) may not be driven at all (to make a pure red) or may be driven with less intensity (to make different shades of red as may be called for by the image content). As another example, if there is relatively dim red content in another portion of the image, the red pixels in that region of the display may be driven at a lower intensity; if there is green content in another portion of the image, the green pixels in that region of the display may be driven to be brighter than red and blue pixels; if there is white content in a region, all three RGB colors may be driven in accordance with how bright the content is; and so forth.

While certain display systems may achieve these various brightness levels by driving the pixels at different analog values (e.g., brighter pixels driven with larger voltages or currents than dimmer pixels, etc.), other display systems may achieve desired brightness levels in other ways. For example, binary pulse-width modulation (PWM) systems may be configured to drive each pixel using a single analog value for that pixel (e.g., a designated amount of voltage or current that the pixel is always driven with) and may create an appearance of different brightness values using time modulation. More specifically, a display system could include a frame controller that causes the array of pixels to display each image frame by performing a series of successive field updates. One frame time during which a particular image frame (e.g., a frame of video content, etc.) is to be displayed may be subdivided into several shorter time periods during which pixels are driven on and off in accordance with the desired brightness for each pixel. For example, pixels that are to be relatively bright (e.g., red pixels in a region of the display where bright red content is to be displayed) may be driven in an ON state for much or all of the frame time (e.g., many of the subdivided time periods), while pixels that are to be relatively dim (e.g., green and blue in that bright red region of the display) may be left in an OFF state for much or all of the frame time (e.g., many of the subdivided time periods). In other words, to display an image frame during a frame time, a frame controller may cause a sequence of image fields to be displayed one after the other, thereby collectively creating an effect that the panel is showing each pixel at its desired brightness for the entire frame time.

Each different configuration in which the array of pixels is driven during one of these short time periods (the periods into which the overall frame time is subdivided) may be referred to herein as an image field or a subframe. Accordingly, the rapid display of a sequence of such image fields (referred to herein as an image field sequence) during a frame time amounts to a displaying of an image frame with which that image field sequence corresponds. In other words, frame controllers described herein are configured to cause an array of pixels to display an image frame by performing a series of successive field updates from image field to image field in a predetermined image field sequence corresponding to the image frame. A rapid and consecutive display of an entire image field sequence during a frame time is how display systems described herein may display an image frame to which that image field sequence corresponds.

Frame controllers described herein are thus configured to cause an array of pixels to display an image frame by performing the series of successive field updates from image field to image field in an image field sequence corresponding to the image frame, though technical problems may be introduced by physical constraints present in the display system. For example, one technical problem is that the field updates causing the array of pixels to rapidly change from one image field to the next in the image field sequence cannot be performed instantaneously. Each field update takes a certain amount of time from when it begins updating a first unit of pixels (e.g., a first pixel row, etc.) from one image field to the next until it finishes updating a last unit of pixels (e.g., the final pixel row). Generally, the updating of only one display unit (e.g., one pixel row, one multi-row group, one partial row, etc.) can be performed at a time. Accordingly, the various displays units within a particular pixel display must be updated one at a time until all the units are updated.

While any field update will take non-zero time, the fastest field update possible for a given implementation (whether or not field updates are actually performed in this way by the implementation) would be performed by a singular write pointer tracking a traversal across the entire array of pixels with no interruptions to write to other locations in the array of pixels (other locations being tracked by other write pointers). This shortest amount of time it takes for a single-pointer update in a particular display system may be referred to herein as a minimum panel update period.

A technical problem arises when the minimum panel update period for a certain display panel is too long to be able to meet dynamic range targets, frame rate targets, power targets, and so forth. If the minimum panel update period represents the shortest amount of time that any given image field can be displayed during the image field sequence (i.e., the shortest field duration that is supported by the system), this minimum panel update period puts a significant constraint on how dim any pixel can be, and, therefore, a constraint on the dynamic range that the image display can provide and the frame rate that the image display can support. Unfortunately, most options for decreasing the minimum panel update period of a particular system involve increasing its power consumption, increasing the complexity and cost, or otherwise compromising design targets.

As set forth in detail below, systems and methods described herein provide a technical solution for this problem by employing overlapping image field updates enabled by using a plurality of different write pointers that traverse the array of pixels concurrently. For example, the series of successive field updates performed by a frame controller described herein may include: 1) a first field update in which a first write pointer circuit tracks a first traversal, during a first update period, across the array of pixels to update the array of pixels from a first image field of an image field sequence to a second image field of the image field sequence, and 2) a second field update in which a second write pointer circuit tracks a second traversal, during a second update period, across the array of pixels to update the array of pixels from the second image field to a third image field of the image field sequence. By making the second update period of the second field update overlap the first update period of the first field update, a field duration of the second image field may be made to be extremely short. In one example, for instance, as soon as a first row of pixels is updated from the first image field to the second image field and the first write pointer moves on to begin updating a second row of pixels, the second write pointer may point to the first row and begin updating it from the second image field to the third image field in the image field sequence. As such, for an example display panel with 1000 rows of pixels, the field duration of the second image field would be only the amount of time it takes to update one row, rather than the time it takes to update the entire panel (i.e., 1/1000^{th} that of the minimum panel update period in this example).

The technical effect and benefits of this solution are therefore a great increase in the dynamic range that a display system of this type (e.g., a display system relying on binary PWM or another image-field-based display approach) is capable of supporting, with minimal or no compromise to the system's power consumption, frame rate, complexity, or cost. As another beneficial technical effect, this significant decrease in the minimum field duration provided by such overlapping image field updates may also result in increased design flexibility. For example, there may be increased flexibility in how images can be encoded into image field sequences and how these sequences are designed. While outside the scope of the present disclosure, it is known that various factors and considerations may be accounted for in this encoding process, such that providing additional flexibility in how image field sequences may be arranged, ordered, configured, and so forth, may benefit the overall display system in many ways.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods implementing overlapping image field updates in a display system may result in any or all of the technical benefits mentioned above, as well as various additional and/or alternative technical effects mentioned above, as well as various additional effects and benefits that will be described and/or made apparent below.

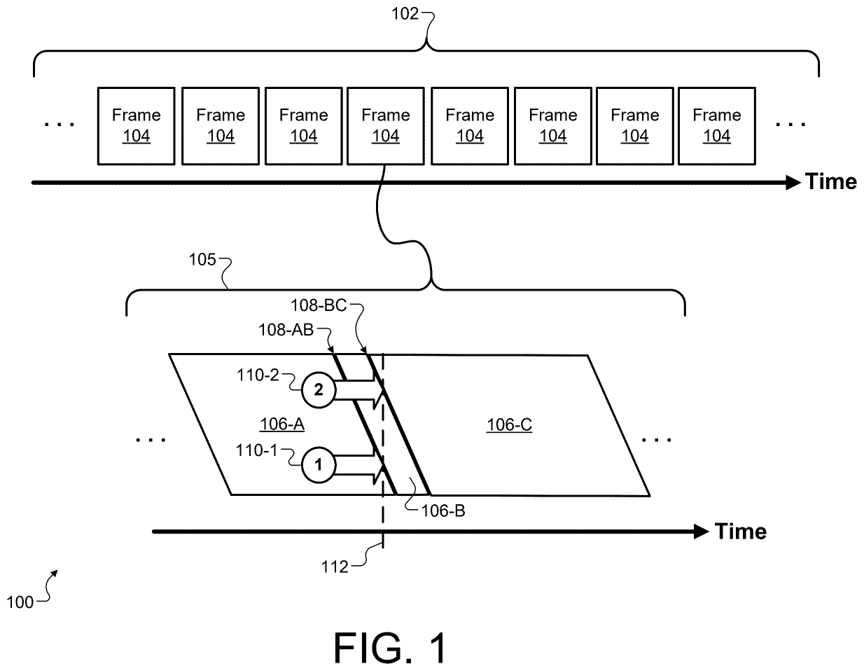

FIG. 1 shows certain aspects of an illustrative implementation 100 of overlapping image field updates in a display system in accordance with principles described herein. In FIG. 1 a frame sequence 102 is shown to include a plurality of image frames 104 that are displayed, one after the other in sequence, with respect to time. Time is represented on a timeline under frames 104 to indicate that each frame is presented for a certain frame time. For example, if frame sequence 102 represents a video that is configured to be presented at 60 frames per second (fps), the frame time during which each of frames 104 would be presented would be 1/60^{th} of a second, or approximately 16.7 milliseconds.

Beneath the timeline showing frames 104 of the frame sequence, FIG. 1 shows a frame time 105 during which a single frame 104 is shown to be presented by way of image fields (also referred to as subframes) of an image field sequence that corresponds to the particular frame 104. More specifically, FIG. 1 shows an image field sequence that includes at least an image field 106-A, followed by an image field 106-B, followed by an image field 106-C. Ellipses before and after these image fields indicate that the image field sequence corresponding to this image frame 104 may further include additional image fields either prior to image field 106-A or after image field 106-C.

Between different image fields in the image field sequence of FIG. 1, a series of field updates is shown with labels tied to the letter for each field sequence. For example, a field update 108-AB illustrates where image field 106-A is updated to image field 106-B, after which a field update 108-BC illustrates where image field 106-B is updated to image field 106-C. Other field updates not explicitly shown and/or labeled may be performed to successively move through the image field sequence during the course of the one frame time associated with this image frame 104. In particular, as shown, after image field 106-A has been displayed for a first field duration, field update 108-AB is performed to transition the array of pixels from image field 106-A to image field 106-B. Then, after image field 106-B has been displayed for a second field duration (a far shorter duration in this example), field update 108-BC is performed to transition the array of pixels from image field 106-B to image field 106-C.

The image field representations in FIG. 1 are shown to have two dimensions. In the horizontal direction, time is represented indicating how long each image field is displayed (the width dimension along the time axis). The vertical direction, however, will be understood to represent the various rows (or other units) of pixels in the panel. Since updating the pixels takes a finite amount of time per row (pixels in the panel cannot transition instantaneously), field updates 108-AB and 108-BC are shown to be sloped with respect to the horizontal time axis. The slope of these field updates with respect to the timeline show how, at any given point in time, some of the pixels on the panel (e.g., those that have already transitioned to the next image field) may be displaying one image field, while other pixels on the panel (e.g., those that have not yet transitioned) may be displaying a different image field. In other words, as write pointers 110-1 and/or 110-2 traverse the array of pixels to update the array of pixels, write pointers circuits track this traversal by storing an address (e.g., a row number or another address of another suitable pixel unit) within the panel where the field update is currently taking place. Pixels that have already been traversed by a write pointer and updated may display one image field while pixels that have not yet been traversed by the write pointer for the update may display a different image field.

As used herein, a write pointer refers to a location in the array of pixels where a field update is being performed at any given time. As the entire array of pixels cannot be updated simultaneously, write pointers must traverse across the array of pixels (e.g., one pixel at a time, one row at a time, etc.) during a finite time period (i.e., an update period) to perform a field update from one image field to another. While the write pointers themselves may be intangible by nature (e.g., a number representing a pixel or row position, etc.), write pointers may be managed using concrete circuitry such as hardware registers, a location in transitory memory where the pointer is stored, custom circuitry configured especially for tracking traversals across the array of pixels, or the like. Accordingly, as used herein, write pointer circuits will be described as tracking traversals across arrays of pixels during update periods. These write pointer circuits may be configured to store, update, and/or otherwise manage write pointers, and may be implemented in any suitable hardware (e.g., custom circuitry, dedicated registers, locations in memory, other suitable circuits, etc.). While one write pointer circuit may track only a single location in the pixel array at once (so as to manage only a single traversal across the pixels at a time), systems and methods described herein employ a plurality of write pointer circuits so as to track multiple locations in the pixel array at the same time (to allow multiple field updates such as field updates 108-AB and 108-BC to be performed concurrently or to overlap).

To illustrate, the first write pointer 110-1 (labeled “1” in FIG. 1) is shown in this example to be used for field update 108-AB. At an earlier time than is snapshotted in FIG. 1, write pointer 110-1 may have started with a first row of pixels represented at the top of image field 106-A and transitioned these pixels to image field 106-B. As time progresses, write pointer 110-1 would effectively move down the slope of field update 108-AB as each unit of pixels is transitioned from image field 106-A to image field 106-B. At the moment snapshotted in FIG. 1, write pointer 110-1 is shown to be near the bottom of the slope, indicating that field update 108-AB is nearly complete and write pointer 110-1 will soon be freed up to track another field update. However, as illustrated by the intersection of a vertical line 112 with both field update 108-AB and field update 108-BC, the time snapshotted for FIG. 1 involves two overlapping (concurrent) image field updates happening at once. While write pointer 110-1 shows that field update 108-AB is still ongoing, the field duration of image field 106-B is so short that write pointer 110-2 is shown to have already started at the top to transition pixel units from image field 106-B to image field 106-C as part of field update 108-BC. As is clearly illustrated at the time associated with vertical line 112, the field duration of image field 106-B (i.e., the thinness of the parallelogram representing image field 106-B) is shorter than the minimum panel update period and thus is only made possible by having more than one write pointer working at once.

Overlapping (concurrent) image field updates, such as illustrated by field updates 108-AB and 108-BC, may create technical benefits such as shorter field durations that allow for increased dynamic range and other advantages described herein. At the time associated with vertical line 112, for example, certain pixel units (near the top) have already undergone both field updates 108-AB and 108-BC, such that these pixel units are displaying image field 106-C. Other pixel units (in the middle) have undergone field update 108-AB so as to be displaying image field 106-B, but have not yet undergone field update 108-BC (as the traversal tracked by the second write pointer 110-2 has yet to reach these pixel units). Still other pixel units (near the bottom) have yet to undergo either field update 108-BC or field update 108-AB, such that these are still displaying image field 106-A. Accordingly, as shown (and to the benefit of the system in the ways that have been described), the field duration of image field 106-B is considerably shorter than the update periods of either of field updates 108-AB or 108-AB.

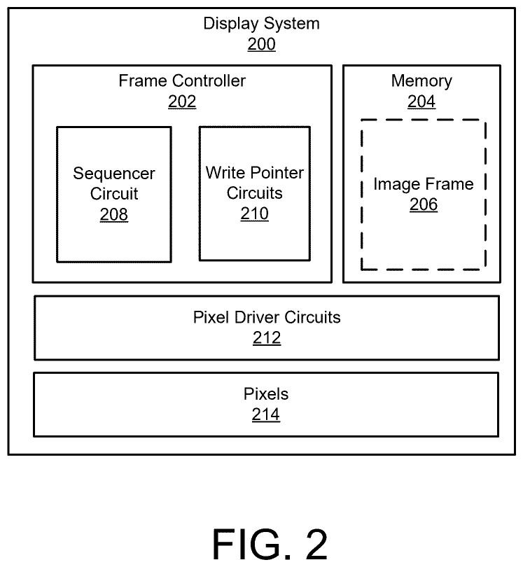

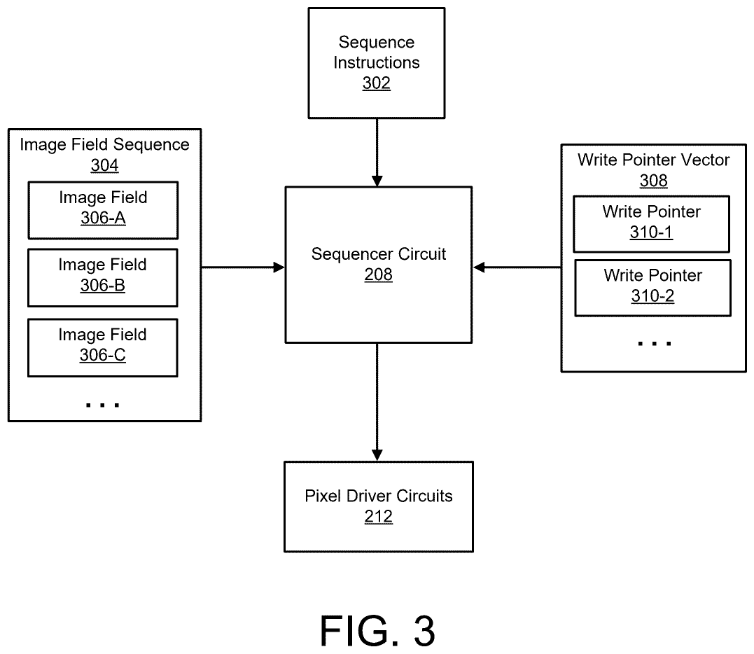

Having illustrated an implementation of overlapping image field updates that a display system may perform in FIG. 1, FIGS. 2 and 3 will now illustrate aspects of a display system including certain system components (data, hardware, and/or instructional components) that may interoperate to produce the end result of FIG. 1.

FIG. 2 shows a block diagram of an illustrative display system 200 configured to implement overlapping image field updates in accordance with principles described herein. As shown, display system 200 may feature a frame controller 202 and a memory 204 that stores data for an image frame 206 that is to be displayed by display system 200. Frame controller 202 includes a sequencer circuit 208 and a plurality of write pointer circuits 210 to facilitate the display of image frame 206 in accordance with principles described herein. By performing methods described herein, frame controller 202 may direct pixel driver circuits 212 to cause an array of pixels 214 to present image frame 206 by successively displaying a sequence of image fields such as image fields 106-A through 106-C illustrated above.

The array of pixels 214 may be arranged in any suitable manner, such as in rows, columns, or in a non-rectilinear arrangement in which the pixels may be grouped into other types of units (e.g., partial rows, staggered rows, bunches, etc.). Each pixel 214 in the array may be implemented using any suitable technology. For example, pixels 214 may be implemented as light emitting diodes (LEDs), or, more particularly, as microLEDs that could have a very small pixel pitch and high efficiency. The array of pixel driver circuits 212 may correspond with the array of pixels 214. For example, circuitry of a pixel driver may be included for each individual pixel 214. As mentioned above, pixel driver circuits may be configured to drive the pixels on and off at a very fast and controlled rate (e.g., in connection with image field sequences described herein), but may operate in a binary fashion, such that each pixel is either on or off (and there is no scale of different analog drive strengths or the like).

Memory 204 may represent any suitable buffering hardware that may store all or part of image frame 206 as the image frame is presented. In some examples, display system 200 may include sufficient memory 204 to buffer several image frames at once. Image frame 206 may include data indicating intensity (e.g., brightness) values for each pixel 214 of the array. However, to drive the pixels at those respective intensities using a binary pulse-width modulation (PWM) approach, image frame 206 may be converted into an image field sequence including a plurality of image fields that, when presented in rapid succession, cause the pixels to appear to be at the desired brightnesses based on the portion of the frame time that they are on versus off.

To further illustrate, FIG. 3 shows a block diagram illustrating certain aspects of how sequencer circuit 208 may operate to achieve overlapping image field updates in a display system in accordance with principles described herein. As shown in FIG. 3, sequence instructions 302 (which may also be stored in memory 204 in certain examples) may be executed by sequencer circuit 208 as sequencer circuit 208 drives pixel driver circuits 212 in accordance with the binary PWM scheme. Specifically, an image field sequence 304 including a plurality of image fields 306-A, 306-B, 306-C, etc., is sequenced to the pixels using a write pointer vector 308 with a plurality of write pointers 310-1, 310-2, and so forth. As shown by ellipses in FIG. 3, any suitable number (including greater than 3) of image fields may be included in image field sequence 304. Additionally, a suitable plurality of write pointers may be included within write pointer vector 308, based on tradeoff principles described below.

Sequencer circuit 208 may be configured to cause the array of pixels 214 to display an image frame by performing a series of successive field updates to move through image field sequence 304 using write pointer vector 308. For example, sequence instructions 302 may direct sequencer circuit 208 to perform a series of successive field updates. The series may include, for instance, a first field update in which a first write pointer circuit associated with write pointer 310-1 tracks a first traversal, during a first update period, across the array of pixels 214 to update the array of pixels 214 (by way of the pixel driver circuits 212) from a first image field 306-A of image field sequence 304 to a second image field 306-B of image field sequence 304. The series of successive field updates may further include a second field update in which a second write pointer circuit associated with write pointer 310-2 tracks a second traversal, during a second update period, across the array of pixels 214 to update the array of pixels 214 (by way of the pixel driver circuits 212) from the second image field 306-B to a third image field 306-C of image field sequence 304. The series of successive field updates may further include additional field updates to reuse write pointers 310-1 and/or 310-2, as well as to employ other write pointers within write pointer vector 308 to track additional traversals across the pixels to update them to additional image fields within image field sequence 304. As illustrated above, one benefit of using separate and independent write pointers to perform these field updates is that the second update period of the second field update may overlap the first update period of the first field update. In other words, the second field update employing write pointer 310-2 may begin even while the first field update employing write pointer 310-1 is still ongoing.

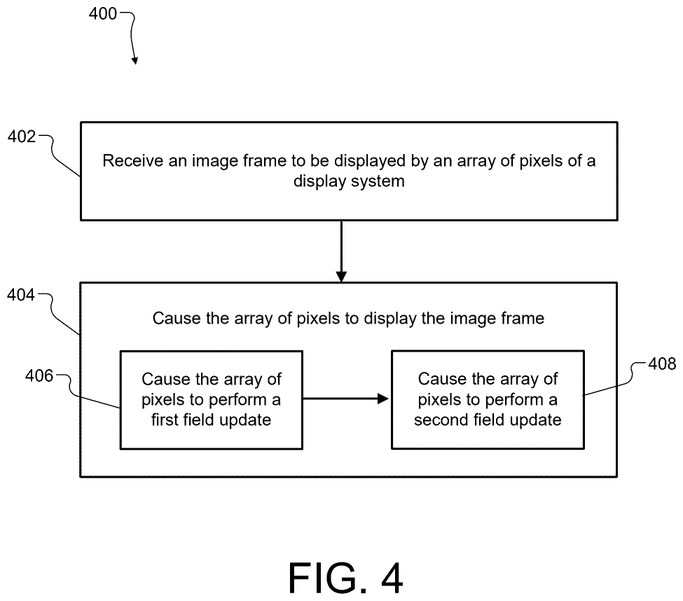

FIG. 4 shows an illustrative method 400 for performing overlapping image field updates in a display system in accordance with principles described herein. For example, method 400 may be embodied within sequence instructions 302, such that frame controller 202 may perform method 400 using sequencer circuit 208 and a plurality of write pointer circuits 210 (e.g., to track a write pointer vector such as write pointer vector 308). While FIG. 4 shows illustrative operations according to a specific implementation, it will be understood that other implementations of these methods may omit, add to, reorder, and/or modify any of operations 402-408 that are explicitly represented in FIG. 4. Additionally, while operations 402-408 are illustrated with arrows suggestive of a sequential order of operation, it will be understood that some or all of the operations of method 400 may be performed concurrently (e.g., in parallel) with one another. Each of the operations of method 400 will now be described in more detail as the operations may be performed by an implementation of display system 200.

At operation 402, the display system (e.g., using a frame controller configured to perform binary pulse-width modulation) may receive an image frame (e.g., image frame 206) to be displayed by an array of pixels (e.g., pixels 214) of the display system. For example, as illustrated above, the image frame may be one frame included in a sequence of image frames (e.g., a video frame or the like).

At operation 404, the display system may cause the array of pixels to display the image frame by performing a series of successive field updates. For example, the image frame may be converted into an image frame sequence that, when presented in rapid sequence in accordance with the binary PWM scheme, causes each pixel in the array of pixels to have a desired apparent brightness. As shown within operation 404, two sub-operations 406 and 408 may be performed to cause the array of pixels to display the image frame.

First, at sub-operation 406, a first field update may be performed in which a first write pointer circuit tracks a first traversal, during a first update period, across the array of pixels. In this way, as has been described, the array of pixels may be updated from a first image field of an image field sequence to a second image field of the image field sequence.

Then, at sub-operation 408, a second field update may be performed in which a second write pointer circuit tracks a second traversal, during a second update period, across the array of pixels to update the array of pixels from the second image field to a third image field of the image field sequence. As has been described and as will be illustrated in more detail below, these field updates may be performed concurrently, or at least partially at the same time. More specifically, the second update period of the second field update may overlap the first update period of the first field update by the second update period beginning while the first update period is still ongoing.

In some implementations, a method such as method 400 may be embodied as a process within a memory. For example, method 400 may be embodied by sequence instructions 302 and stored in memory 204 or elsewhere. A non-transitory computer-readable medium (e.g., such as implemented by memory 204 in certain implementations) may store instructions that, when executed, cause a processor (e.g., such as sequencer circuit 208) to perform a process embodying method 400. Specifically, when executing the instructions on the non-transitory computer-readable medium, the processor may: 1) receive an image frame to be displayed by an array of pixels of the display system; and 2) cause the array of pixels to display the image frame by performing a series of successive field updates. The series of successive field updates may include: 1) a first field update in which a first write pointer circuit tracks a first traversal, during a first update period, across the array of pixels to update the array of pixels from a first image field of an image field sequence to a second image field of the image field sequence; and 2) a second field update in which a second write pointer circuit tracks a second traversal, during a second update period, across the array of pixels to update the array of pixels from the second image field to a third image field of the image field sequence. The second update period of the second field update may overlap the first update period of the first field update.

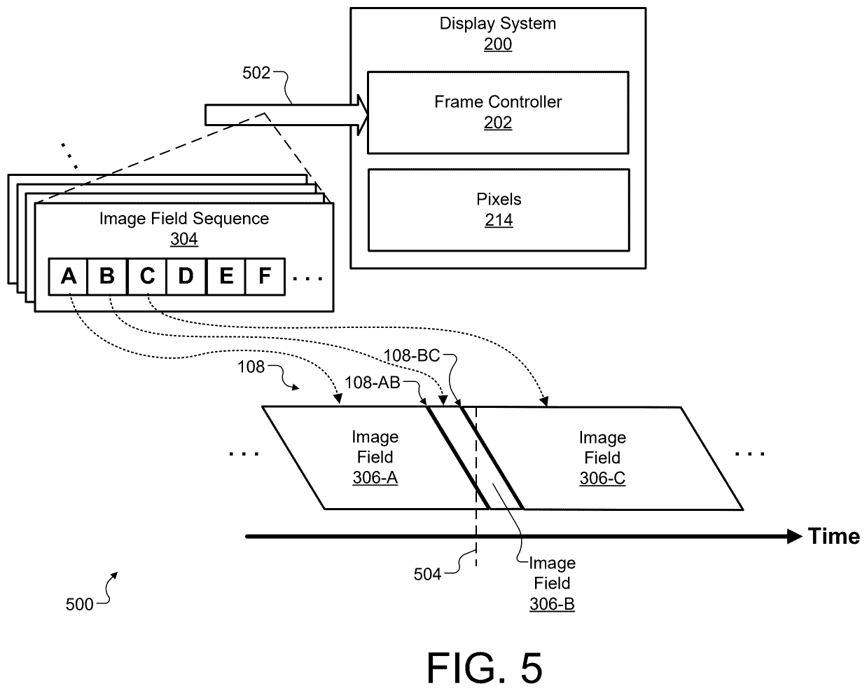

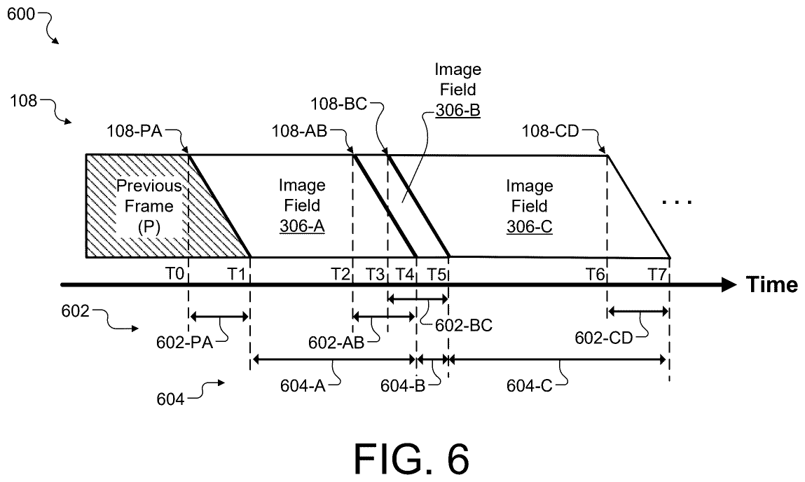

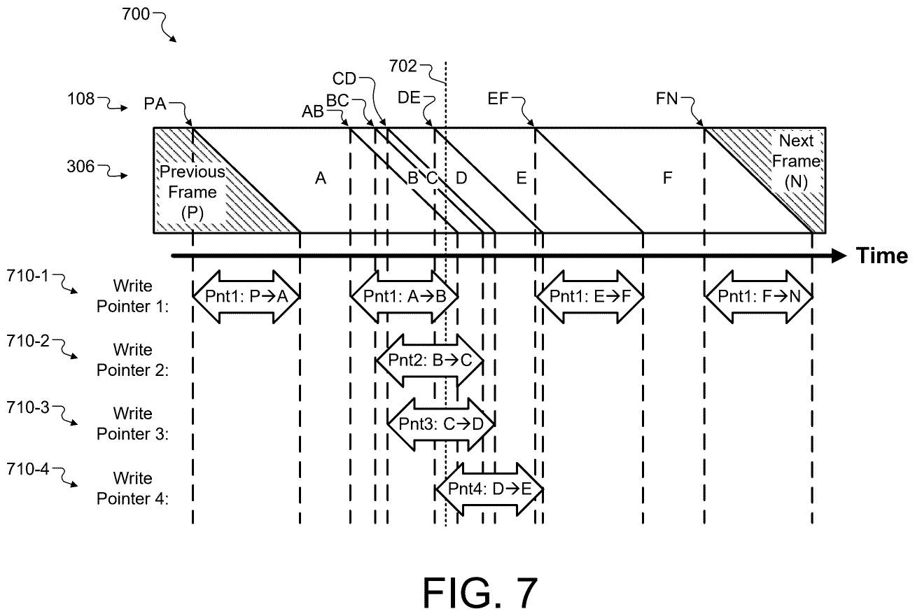

Having illustrated an implementation of overlapping image field updates and various details for display systems and methods for achieving them, FIGS. 5-7 will now be described to bring these concepts together and to illustrate certain timing-related and other details. More particularly, FIG. 5 shows certain aspects of how an illustrative display system may perform overlapping image field updates to present image frames based on image field sequence data; FIG. 6 emphasizes various timing-related aspects of an implementation of overlapping image field updates; and FIG. 7 shows additional aspects of an implementation of overlapping image field updates that includes multiple overlapping updates supported by a set of more than two write pointers.

FIG. 5 shows a simplified implementation 500 that includes an implementation of display system 200 with the frame controller 202 and the array of pixels 214. It will be understood that other elements of display system 200 may also be included as described herein, though those elements are not explicitly drawn in FIG. 5. Frame controller 202 is shown to receive image data 502 that represents data that is to be used by display system 200 to display images (e.g., images frames such as image frame 206). More particularly, image data 502 is shown to include an image field sequence 304 that corresponds to a particular image frame (e.g., image frame 206) that the array of pixels 214 will display when driven (under direction of frame controller 202) to go through each image field in image field sequence 304 during the course of an image frame time.

While not explicitly shown in FIG. 5, it will be understood that display system 200 may further include other components and resources (e.g., processing and memory resources for processing image data 502, buffering for image data 502, pixel drivers for driving pixels 214, etc.). Additionally, while a single image field sequence 304 representing a single image frame (e.g., image frame 206) is shown in FIG. 5 as the focus of this description, additional image field sequences associated with additional image frames are shown to be represented in FIG. 5 by similar boxes lined up behind the image field sequence 304 and an ellipsis suggesting that there may be an arbitrary number of these image field sequences and image frames (e.g., to present a video sequence, etc.).

Image field sequence 304 is shown to include a plurality of image fields 306-A through 306-F (with an ellipsis indicating that more or fewer image fields may be included in the sequence as may serve a particular implementation). These individual image fields are represented by boxes labeled ‘A’, ‘B’, ‘C’, and so forth in the box of image field sequence 304, then dotted arrows show a correlation with certain of these representations and another representation of image fields 306-A through 306-C (the other image fields 306 are not explicitly shown in this latter representation) along a timeline similar to the timeline described above in relation to FIG. 1. While image field sequence 304 is shown to be part of image data 502 and to be originating from somewhere outside of display system 200, it will be understood that, in certain implementations, display system 200 itself may create the image field sequence 304 based on image data 502 that is received from an internal or external source and is not yet configured as an image field sequence. For example, converting image data into image field sequences such as image field sequence 304 may be a role performed by sequencer circuit 208 in certain implementations. Regardless of where image data 502 and the image field sequence 304 originate, these may be received by frame controller 202 and processed in accordance with principles described herein.

Similar to the timeline described in relation to FIG. 1, FIG. 5 represents the various image fields of image field sequence 304 along a timeline (“Time”) near the bottom of the figure. A series of field updates 108 (e.g., a first field update 108-AB, a second field update 108-BC, and other field updates not explicitly shown and/or labeled) may be performed to successively move through image field sequence 304 during the course of one frame time associated with an image frame (e.g., image frame 206). In particular, as shown, after image field 306-A has been displayed for a first field duration, field update 108-AB is performed to transition the array of pixels 214 from image field 306-A to image field 306-B. Then, after image field 306-B has been displayed for a second field duration, field update 108-BC is performed to transition the array of pixels 214 from image field 306-B to image field 306-C.

As described above in relation to FIG. 1, the image field representations along the timeline in FIG. 5 are shown to have two dimensions to not only represent the duration that each image field is displayed (the width dimension along the timeline) but also to represent the fact that not all of pixels 214 in the panel can transition instantaneously (the height dimension orthogonal to the timeline). In other words, the slope of the illustrated field updates 108 with respect to the timeline illustrates that, at any given time, some of pixels 214 may be displaying one image field while other pixels 214 may be displaying a different image field. In other words, as a write pointer circuit tracks a traversal across the array of pixels to update the array of pixels, pixels that have already been traversed by the write pointer and updated may display one image field while pixels that have not yet been traversed by the write pointer for the update may display a different image field.

As has been described, display system 200 may be configured to perform overlapping (concurrent) image field updates to create certain technical benefits such as shorter field durations that allow for increased dynamic range and other advantages. To illustrate this overlap, a particular time 504 is shown in FIG. 5 where field update 108-AB and field update 108-BC are overlapping (i.e., both occurring concurrently or at the same time). As has been described, this overlap may be enabled by the use of more than one write pointer circuit to track more than one traversal through the array of pixels so that both can happen during the same overlapping period. At time 504, for example, certain pixels 214 (near the top) have already undergone both field updates 108-AB and 108-BC, such that these are displaying image field 306-C. Other pixels 214 (in the middle) have undergone field update 108-AB so as to be displaying image field 306-B, but have not yet undergone field update 108-BC (as the traversal tracked by the second write pointer circuit has yet to reach these pixels). Still other pixels 214 (near the bottom) have yet to undergo either field update 108-AB or field update 108-BC, such that these are still displaying image field 306-A. Accordingly, as shown (and to the benefit of the system in the ways that have been described), the field duration of image field 106-B is considerably shorter than the update periods of either of field updates 108-AB or 108-BC.

Binary PWM techniques described herein modulate the brightness of various pixels (and thereby also modulate color as different brightness combinations of primary colors are mixed) by rapidly switching pixels on and off in accordance with image fields within a given image field sequence. For example, a given pixel could be switched on for all the image fields of image field sequence 304, making the pixel appear at maximum brightness, switched off for all the image fields of image field sequence 304, making the pixel appear black, or switched on and off for different image fields to achieve a non-zero brightness that is also less than the maximum. For instance, a pixel that is on for only image field 306-B would appear very dim (but still on), another pixel that is on for only image field 306-A would appear brighter (since the field duration of image field 306-A is longer than that of image field 306-B), and yet another pixel that is on for both image field 306-A and 306-B would be brighter still. By having various image fields of various different field durations for each frame, any given pixel may be made to appear at many distinct levels of brightness based on the combination of image fields for which the pixel is switched on and off.

In some examples, image data 502 may define multi-bit brightness values for each of the pixels 214 in the array. For example, an 8-bit brightness value would correspond to 28=256 different brightness levels possible (from 0b00000000 to 0b11111111). For an image frame displayed using a binary PWM technique, an array of multi-bit brightness values may be applied to the array of pixels that corresponds to the array of pixels for the image frame. For example, a first image field (e.g., image field 306-A) of the image field sequence (e.g., image field sequence 304) may include a first array of binary values forming a first bit plane of the array of multi-bit brightness values. A second image field (e.g., image field 306-B) of the image field sequence may include a second array of binary values forming a second bit plane of the array of multi-bit brightness values. A third image field (e.g., image field 306-C of the image field sequence may include a third array of binary values from a third bit plane of the array of multi-bit brightness values, and so forth.

Thus, for example, an implementation using 8-bit brightness values could use an image field sequence with eight image fields of varying durations—the longest duration (i.e., the widest image field) being used for the most significant bit of the multi-bit brightness values, the second longest duration being used for the second most significant bit of the multi-bit brightness values, and so forth down to the shortest duration (i.e., the thinnest image field) being used for the least significant bit of the multi-bit brightness values. To give one arbitrary example, if an 8-bit brightness value for a certain pixel were 0b00110001, the pixel could be driven OFF for the two longest duration image fields (since its two most significant bits are ‘0’), ON for the third and fourth longest duration image fields (since its third and fourth most significant bits are ‘1’), OFF for the fifth through seventh longest duration image fields (since these bits are again ‘0’), and, finally, ON for the shortest duration image field (since the eighth, least significant bit is ‘1’). It will be understood that these various image fields need not be presented in any particular order (e.g., from longest to shortest), and that, in fact, there may be advantages of being able to flexibly order the various image fields in a variety of ways. It will also be understood that this one-to-one mapping of brightness value bits to image fields or subframes is given by way of example only, and that there are other (e.g., more complex) ways that brightness data can be converted to bitfield data in implementations with, for instance, more than eight different subframes.

In this type of implementation, each image field of the image field sequence (e.g., image fields 306-A through 306-F, etc.) may include an array of binary values corresponding to the array of pixels (i.e., binary values representing on or off for each pixel). In other types of implementations, however, multi-bit values, rather than binary values, could similarly be used, for instance, with pixels that are configured to be powered on at multiple levels of brightness. In these examples, then, each image field of the image field sequence may include an array of multi-bit values corresponding to the array of pixels.

As has been described, one advantage of using multiple write pointers is that it allows for image fields to be shorter than the minimum panel update period (i.e., the length in time that it takes to complete an entire field update). As shown in FIG. 5, for example, image field 306-B is shorter in duration than either of field updates 108-AB or 108-BC. In this way, image field 306-B could be used for a bit plane associated with one of the least significant bits of a multi-bit brightness value assigned to each of the array of pixels 214. At the limit, the shortest duration image field (i.e., the thinnest image field) that could be provided by a display system with multiple write pointers would be one in which as soon as a first writeable unit (referred to herein as a display unit) is transitioned to one image field and the write pointer moves to a second unit, a second write pointer is used to rewrite the first writeable unit to the next image field.

More particularly, given an implementation in which the array of pixels 214 is arranged on a display panel with respect to a plurality of display units (e.g., pixel rows or other addressable groups into which the pixel array is organized), the first write pointer circuit could, during a first field update (e.g., field update 108-AB), track the plurality of display units, beginning with a first display unit, to update each of the plurality of display units, while the second update period of a second field update (e.g., field update 108-BC) could begin immediately subsequent to the first display unit being updated. For instance, the plurality of display units may be implemented as single rows on the display panel, such that field update 108-BC could begin on a first row of the panel immediately subsequent to the completion of field update 108-AB for that first row. As another example, the plurality of display units may be implemented as multi-row units (e.g., groupings of two or more rows each) on the display panel, such that field update 108-BC could begin on a first multi-row group of the panel immediately subsequent to the completion of field update 108-AB for that multi-row group. As yet another example, the plurality of display units may be implemented as partial rows on the display panel, such that field update 108-BC could begin on a first partial row (e.g., a grouping of one or more pixels on the row) of the panel immediately subsequent to the completion of field update 108-AB for that first partial row.

As these updates are made unit by unit (e.g., row by row, etc.), it will be understood that the updates may move from a top row to a bottom row (or from the bottom row to the top row) in consecutive order, though such a consecutive ordering is not necessarily used or ideal for every implementation. More particularly, for certain implementations in which the array of pixels 214 is arranged in a plurality of rows on a display panel, each traversal across the array of pixels 214 may be performed in a sequential update order that begins with a top row of the plurality of rows and continues sequentially through successive rows until reaching a bottom row of the plurality of rows. In other implementations in which the array of pixels 214 is arranged in the plurality of rows on the display panel, however, the traversals may be performed out of order. For example, each traversal across the array of pixels 214 may be performed in a nonsequential update order distinct from the sequential update order that begins with the top row and continues sequentially through successive rows until reaching the bottom row. For example, by traversing through the display units (e.g., rows, multi-row groups, partial rows, etc.) in a random or quasi random order, certain undesirable artifacts and effects may be avoided or mitigated that might otherwise occur when sequentially ordered updates are used.

FIG. 6 shows certain timing-related aspects of an implementation 600 of overlapping image field updates in a display system in accordance with principles described herein. In FIG. 6, image field 306-A is explicitly shown to represent the first image field of image field sequence 304 that is being displayed as an earlier image frame (“Previous Frame (P)”) is being replaced. A field update 108-PA is explicitly labeled to show this first transition from the previous image frame (P) to the first image field 306-A of the new image frame. Along with field updates 108-AB and 108-BC (which were described above), FIG. 6 also shows another field update 108-CD to indicate a transition from image field 306-C to an image field D (not explicitly shown) that will be understood to take place at that point in time.

Also shown in FIG. 6 are various events labeled along the timeline as “Tn,” where n is an integer 0-7 (to distinguish the events from one another). These events are shown with dashed lines extending up to the beginnings and ends of the various field updates 108 to indicate the events that are being called out. Specifically, as shown, event T0 occurs when field update 108-PA begins, event T1 occurs when field update 108-PA ends, event T2 occurs when field update 108-AB begins, event T3 occurs when field update 108-BC begins, event T4 occurs when field update 108-AB ends, event T5 occurs when field update 108-BC ends, event T6 occurs when field update 108-CD begins, and event T7 occurs when field update 108-CD ends.

Extending between these events, FIG. 6 shows update periods 602 for each field update 108 and field durations 604 for each image field 306 (the duration explicitly illustrated for whichever pixels are last updated, though it will be understood that each pixel displays each image field for a same field duration as other pixels even if not during the same period of time). More particularly, an update period 602-PA shows how long field update 108-PA takes, an update period 602-AB shows how long field update 108-AB takes, an update period 602-BC shows how long field update 108-BC takes, and an update period 602-CD shows how long field update 108-CD takes. In this example, each update period 602 is shown to take a same amount of time, though they occur at different points on the timeline.

In contrast, field durations 604 are shown to each be unique in the amount of time they take. FIG. 6 shows a field duration 604-A during which image field 306-A is displayed, a field duration 604-B during which image field 306-B is displayed, and a field duration 604-C during which image field 306-C is displayed, each of which is different in length. Specifically, as shown, field duration 604-B is relatively short in length (shorter than either of the other field durations 604 and even shorter than the update periods 602). Field duration 604-A is longer than field duration 604-B and the update periods 602, and field duration 604-C is longer still.

Put together, FIGS. 5 and 6 are illustrative of various principles relating to overlapping image field updates and the technical benefits that may be provided thereby.

As one example, these figures show display system 200 comprising the array of pixels 214 and the frame controller 202 that is configured to cause the array of pixels 214 to display an image frame by performing a series of successive field updates 108. The series of successive field updates 108 is shown to include the first field update 108-AB in which a first write pointer circuit tracks a first traversal, during a first update period 602-AB, across the array of pixels 214 to update the array of pixels from a first image field 306-A of an image field sequence 304 to a second image field 306-B of the image field sequence. The series of successive field updates 108 is further shown to include a second field update 108-BC in which a second write pointer circuit tracks a second traversal, during a second update period 602-BC, across the array of pixels 214 to update the array of pixels from the second image field 306-B to a third image field 306-C of the image field sequence 304. As shown, the second update period 602-BC of the second field update 108-BC overlaps the first update period 602-AB of the first field update 108-AB. This allows field duration 604-B to be even shorter than any of update periods 602, which would not be possible if the entire array of pixels had to be updated before a new update could begin (i.e., if only a single write pointer circuit was used and update periods 602-AB and 602-BC did not overlap).

As has been mentioned, a minimum panel update period may be defined as a time period in which the frame controller 202 could use a single write pointer circuit to track traversal across the array of pixels to update the array of pixels. As mentioned above, writing to the array of pixels is performed at one location (i.e., one display unit) at a time. As such, an example that uses two different write pointers to point to two separate display units (such as the example illustrated in FIGS. 5 and 6) will be understood to take longer than the minimum panel update period (since updates to pixels at the positions tracked by the two write pointers will be interleaved). Accordingly, the first update period 602-AB and the second update period 602-BC may each be at least twice the minimum panel update period. This allows the second image field 306-B to be displayed for the second field duration 604-B shorter than the minimum panel update period, though two short field durations in a row would not be able to be performed using only these two write pointer circuits. Indeed, the cost of having a short field duration 604-B for image field 306-B is that, as shown, the third image field 306-C is displayed for a third field duration 604-C that is longer than the minimum panel update period, such that a sum of the second field duration 604-B and the third field duration 604-C is at least twice the minimum panel update period. Indeed, every two consecutive field durations 604 on a rolling basis (e.g., field durations 604-A and 604-B, field durations 604-B and 604-C, etc.) would sum to at least twice the minimum panel update period for an implementation using two write pointer circuits.

It is noted that even when fewer than all of the available write pointers are being used (e.g., a time when only one field update is ongoing though two write pointers are available, for example), the pace of the update (reflected by the slope of the field update) may be maintained so that each field duration is consistent throughout the array (i.e., every pixel displays every image field for the same amount of time, regardless of its position). In other words, regardless of how many write pointers are actually being used at a given moment, the update period may be configured to be the same for each field update (e.g., the slope being dictated by the maximum number of write pointers used at any time during the sequence).

By adding additional write pointer circuits and additional concurrent traversals across the array of pixels, the update periods 602 of all the field updates 108 would get longer, but, as long as a rolling window of consecutive field durations 604 is long enough, short field durations (similar to field duration 604-B) may be arranged consecutively to one another to provide further flexibility. For example, if the minimum panel update period is again defined as a time period in which the frame controller uses a single write pointer circuit to track traversal across the array of pixels to update the array of pixels, the series of successive field updates 108 could further include a third field update in which a third write pointer circuit tracks a third traversal, during a third update period, across the array of pixels to update the array of pixels from the third image field to a fourth image field of the image field sequence. In this case, the first update period, the second update period, and the third update period would each be at least three times the minimum panel update period, but two short field durations 604 could be placed consecutively in the image field sequence 304. Specifically, the second image field in this example could be displayed for a second field duration shorter than the minimum panel update period and the third image field could be displayed for a third field duration shorter than the minimum panel update period as long as the fourth image field is displayed for a fourth field duration longer than the minimum panel update period, such that a sum of the second field duration, the third field duration, and the fourth field duration is at least three times the minimum panel update period.

To illustrate, FIG. 7 shows additional aspects of an implementation 700 of overlapping image field updates in a display system in accordance with principles described herein. Similar elements are shown in implementation 700 as have been shown and described in other figures described above. However, whereas other examples above included two write pointer circuits tracking traversals across the array of pixels, FIG. 7 shows an example in which a larger plurality of write pointer circuits (e.g., four independent write pointers in this example) allows for even more design flexibility for a given implementation. More particularly, two write pointers such as illustrated in FIGS. 5 and 6 have been shown to allow for one short-duration image field 306 (e.g., image field 306-B) as long as it is surrounded by longer-duration image fields (e.g., image fields 306-A and 306-C), with a limitation that the combined duration of any two consecutive field durations must be at least twice as long as a minimum panel update period. The two-pointer implementation illustrated in FIGS. 5 and 6 would not, therefore, be able to have two short-duration image fields next to each other in the image field sequence.

As illustrated in FIG. 7, the amount of flexibility that an image field sequence 304 is designed with may be subject to a tradeoff between ordering limitations on the one hand (e.g., limitations such as how many relatively short-duration image fields can be placed consecutively in the sequence) and the length of the update periods 602 on the other hand. More particularly, to achieve consecutive (or closely placed) short-duration image fields may require multiple write pointers to be used, which in turn may increase the update period, since the update period is proportional to the number of write pointers being used (e.g., greater than or equal to the minimum panel update period multiplied by the number of write pointers employed). Accordingly, if too few write pointers are used, no single image fields may be very short in duration (the minimum panel update period would present a lower limit), while if too many write pointers are used, the update period of each field update could be so long as to cause undesirable artifacts as different parts of the panel are showing many different subframes at any point in time and the update period of any field update grows to be as long as the entire frame time.

Accordingly, the tradeoff may be managed sensibly to choose a reasonable number of write pointers to avoid overly long update periods while also having sufficient write pointers to allow for flexible ordering of relatively short-duration image fields. A four-pointer implementation that includes several short-duration image fields near one another in the image field sequence is shown in FIG. 7 to illustrate one way these tradeoffs may be managed.

Similar to FIGS. 5 and 6 above, FIG. 7 shows a sequence of image fields 306 labeled, in this case, as individual letters ‘A’ through ‘F’. In this example, these six image fields will be understood to represent all the image fields of a particular image field sequence, such that presenting these image fields in sequence amounts to presenting a single image frame. As shown in shaded portions before and after the image fields 306, this image frame may be preceded by a “Previous Frame” represented by the letter ‘P’ and may be followed by a “Next Frame” represented by the letter ‘N’. As such, a series of successive field updates 108 in FIG. 7 includes a field update 108-PA (labeled as PA) from the Previous Frame, P, to image field 306-A, a field update 108-AB (labeled as AB) from image field 306-A to image field 306-B, a field update 108-BC (labeled as BC) from image field 306-B to image field 306-C, and so forth for field updates labeled CD, DE, EF, and FN.

In this example, as mentioned above, four write pointers 710-1 through 710-4 may be implemented by four write pointer circuits that track traversals through the pixels as updates are made. The field updates managed by each of the write pointers is shown along the timeline with arrows spanning across the respective update period. Each of these arrows is shown to be the same length, since the update period for a four-pointer implementation is the same for each of the field updates (including those field updates in which fewer than four write pointers may be in active use during part or all of the field update, as described above). However, it will be understood that this update period is significantly longer (i.e., the slope of the field updates 108 is significantly more gradual or less steep) than the update periods in other examples described herein as using fewer write pointers (e.g., the two-pointer implementation of FIGS. 5 and 6). More particularly, this update period must be at least four times the minimum panel update period, while the update period for a two-pointer implementation such as illustrated in FIGS. 5 and 6 may be half this length (i.e., double the minimum panel update period).

The benefit gained by accepting this slower update time is shown by the fact that several relatively short-duration image fields 306 may be put next to one another in sequence in this example. Specifically, the image fields labeled B, C, and D are all shown to be relatively short in duration, yet they are all next to one another. As shown by the write-pointer arrows beneath the timeline, this ordering flexibility is made possible by the number of write pointers available in this example. Specifically, as shown, write pointer 710-1 may first be used for field update 108-PA (“Pnt1: P→A”) and then used again for field update 108-AB (“Pnt1: A→B”). However, before field update 108-AB is complete, field updates 108-BC, 108-CD, and 108-DE begin. Since write pointer 710-1 is busy handling field update 108-AB, it would not be able to facilitate field updates 108-BC, 108-CD, or 108-DE so soon, and the field durations of these image fields would need to be longer. However, since write pointers 710-2, 710-3 and 710-4 are available in this implementation, FIG. 7 shows that these short-duration image fields B, C, and D are able to be placed in sequence without problem.

Specifically, while write pointer 710-1 continues transitioning the panel for field update 108-AB (“Pnt1: A→B”), write pointer 710-2 may begin transitioning the panel for field update 108-BC (“Pnt2: B→C”), write pointer 710-3 may begin transitioning the panel for field update 108-CD (“Pnt3: C→D”), and write pointer 710-4 may begin transitioning the panel for field update 108-DE (“Pnt2: D→E”). As such, there is a time 702 during the frame time period where all four write pointers 710-1 through 710-4 are being used and four different field updates 108 are concurrently ongoing. In other words, at time 702, the field durations of five different image fields (A, B, C, D, and E) are shown to be overlapping and four distinct write pointers (write pointers 710-1 through 710-4) are employed to handle the four concurrent field updates. Just before write pointer 710-4 completes field update 108-DE, write pointer 710-1 is shown to be employed to begin transitioning the panel for field update 108-EF (“Pnt1: E→F”), followed by write pointer 710-1 being used to transition the panel for field update 108-FN (“Pnt1: F→N”). Since the field durations of E and F are significantly longer, there is less overlapping in these cases and write pointer 710-1 (or any of the other write pointers) may be capable of handling both transitions by itself, as shown.

As mentioned above, a PWM technique may operate using image fields of differing lengths within an image field sequence. For example, longer-duration image fields may be used for more significant bits of multi-bit brightness values, while shorter-duration image fields may be used for less significant bits of the multi-bit brightness values. This principle is further illustrated by FIG. 7. Specifically, the series of successive field updates is shown to be performed such that each image field 306 of the image field sequence is displayed for a unique field duration distinct from other field durations of other image fields 306 of the image field sequence. In other words, each of the image fields A through F is shown to have a different width-some being quite short or thin (e.g., C, B, D, etc.) and others being much longer or wider (e.g., A, E, and F).

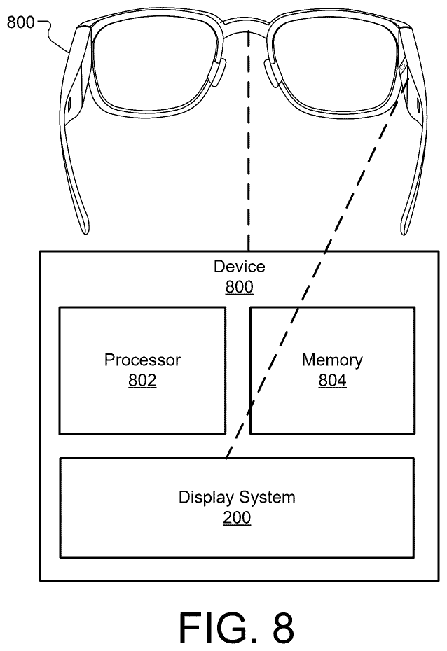

A display system in accordance with principles described herein may be used in a variety of different types of devices to achieve various benefits and advantages as have been described. To illustrate, FIG. 8 shows an illustrative device 800 including an implementation of display system 200 configured to perform overlapping image field updates in accordance with principles described herein.

In this example, device 800 is illustrated as being implemented as an extended reality presentation device. More particularly, the display system 200 is shown to be integrated into a pair of augmented reality glasses for this implementation. MicroLED panels such as may be implemented by display system 200 may be ideal for this type of a device due to their extremely small size, potent brightness, and power efficiency. However, it will be understood that display systems such as display system 200 may not be limited to extended reality devices such as device 800. To the contrary, a display system 200 could be used in devices such as a smartwatch, a mobile device (e.g., a phone, a tablet, etc.), a laptop display, a television, a display panel of an appliance or vehicle, and various other types of devices as may serve a particular implementation.

In virtually any of these example devices, the display system implementation may interoperate with other electronic and/or computing resources. As such, device 800 shows a processor 802 and a memory 804 implemented within device 800 with display system 200. It will be understood that processor 802 and memory 804 may be implemented as any suitable types of processor and storage resources. Additionally, various other elements not shown may further be integrated into a device such as device 800. For example, audio equipment for sound detection and playback, camera devices for capturing images, sensors of various types, input/output interfaces, and various other resources may further be included within the device as may serve a particular implementation.

As has been mentioned, various methods and processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

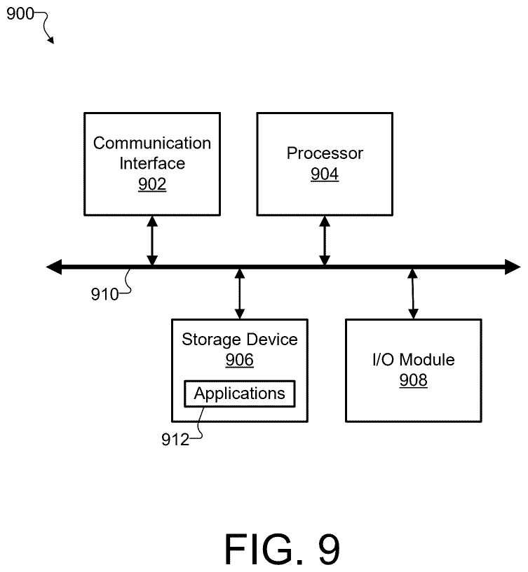

FIG. 9 shows an illustrative computing system 900 that may be used to implement various devices and/or systems described herein. For example, computing system 900 may include or implement (or partially implement) display systems (e.g., display system 200) or devices (e.g., device 800) described herein, any implementations thereof, any components thereof, and/or other devices used therewith.

As shown in FIG. 9, computing system 900 may include a communication interface 902, a processor 904, a storage device 906, and an input/output (I/O) module 908 communicatively connected via a communication infrastructure 910. While an illustrative computing system 900 is shown in FIG. 9, the components illustrated in FIG. 9 are not intended to be limiting. Additional or alternative components may be used in other embodiments. Components of computing system 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data or interpreting, executing, and/or directing execution of one or more of the instructions, processes, and/or operations described herein. Processor 904 may direct execution of operations in accordance with one or more applications 912 or other computer-executable instructions such as may be stored in storage device 906 or another computer-readable medium.

Storage device 906 may include one or more data storage media, devices, or configurations and may employ any type, form, and combination of data storage media and/or device. For example, storage device 906 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 906. For example, data representative of one or more executable applications 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. One or more I/O modules may be used to receive input for a single virtual experience. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

The following examples described implementations of overlapping image field updates in a display system in accordance with principles described herein.

Example 1: A display system comprising: an array of pixels; and a frame controller configured to cause the array of pixels to display an image frame by performing a series of successive field updates, the series of successive field updates including: a first field update in which a first write pointer circuit tracks a first traversal, during a first update period, across the array of pixels to update the array of pixels from a first image field of an image field sequence to a second image field of the image field sequence, and a second field update in which a second write pointer circuit tracks a second traversal, during a second update period, across the array of pixels to update the array of pixels from the second image field to a third image field of the image field sequence; wherein the second update period of the second field update overlaps the first update period of the first field update.

Example 2: The display system of any of the preceding examples, wherein: a minimum panel update period is defined as a time period in which the frame controller uses a single write pointer circuit to track traversal across the array of pixels to update the array of pixels; the first update period and the second update period are each at least twice the minimum panel update period; the second image field is displayed for a second field duration shorter than the minimum panel update period; and the third image field is displayed for a third field duration longer than the minimum panel update period, such that a sum of the second field duration and the third field duration is at least twice the minimum panel update period.

Example 3: The display system of any of the preceding examples, wherein: a minimum panel update period is defined as a time period in which the frame controller uses a single write pointer circuit to track traversal across the array of pixels to update the array of pixels; the series of successive field updates further includes a third field update in which a third write pointer circuit tracks a third traversal, during a third update period, across the array of pixels to update the array of pixels from the third image field to a fourth image field of the image field sequence; the first update period, the second update period, and the third update period are each at least three times the minimum panel update period; the second image field is displayed for a second field duration shorter than the minimum panel update period; the third image field is displayed for a third field duration shorter than the minimum panel update period; and the fourth image field is displayed for a fourth field duration longer than the minimum panel update period, such that a sum of the second field duration, the third field duration, and the fourth field duration is at least three times the minimum panel update period.

Example 4: The display system of any of the preceding examples, wherein the series of successive field updates is performed such that each image field of the image field sequence is displayed for a unique field duration distinct from other field durations of other image fields of the image field sequence.

Example 5: The display system of any of the preceding examples, wherein the first image field of the image field sequence includes an array of binary values corresponding to the array of pixels.

Example 6: The display system of any of the preceding examples, wherein the first image field of the image field sequence includes an array of multi-bit values corresponding to the array of pixels.

Example 7: The display system of any of the preceding examples, wherein: the image frame is displayed by using a binary pulse-width modulation (PWM) technique to apply, to the array of pixels, an array of multi-bit brightness values that corresponds to the array of pixels for the image frame; the first image field of the image field sequence includes a first array of binary values forming a first bit plane of the array of multi-bit brightness values; and the second image field of the image field sequence includes a second array of binary values forming a second bit plane of the array of multi-bit brightness values.

Example 8: The display system of any of the preceding examples, wherein: the array of pixels is arranged in a plurality of rows on a display panel; and the first traversal and the second traversal across the array of pixels are each performed in a sequential update order that begins with a top row of the plurality of rows and continues sequentially through successive rows until reaching a bottom row of the plurality of rows.

Example 9: The display system of any of the preceding examples, wherein: the array of pixels is arranged in a plurality of rows on a display panel; and the first traversal and the second traversal across the array of pixels are each performed in a nonsequential update order distinct from a sequential update order that begins with a top row of the plurality of rows and continues sequentially through successive rows until reaching a bottom row of the plurality of rows.

Example 10: The display system of any of the preceding examples, wherein: the array of pixels is arranged on a display panel with respect to a plurality of display units; during the first field update, the first write pointer circuit tracks the plurality of display units, beginning with a first display unit, to update each of the plurality of display units; and the second update period of the second field update begins immediately subsequent to the first display unit being updated.

Example 11: The display system of any of the preceding examples, wherein the plurality of display units are implemented as single rows on the display panel.

Example 12: The display system of any of the preceding examples, wherein the plurality of display units are implemented as multi-row groups on the display panel.

Example 13: The display system of any of the preceding examples, wherein the plurality of display units are implemented as partial rows on the display panel.

Example 14: A method comprising: causing, by a display system, an array of pixels to display an image frame by performing a series of successive field updates, the series of successive field updates including: a first field update in which a first write pointer circuit tracks a first traversal, during a first update period, across the array of pixels to update the array of pixels from a first image field of an image field sequence to a second image field of the image field sequence, and a second field update in which a second write pointer circuit tracks a second traversal, during a second update period, across the array of pixels to update the array of pixels from the second image field to a third image field of the image field sequence; wherein the second update period of the second field update overlaps the first update period of the first field update.

Example 15: The method of any of the preceding examples, wherein: a minimum panel update period is defined as a time period in which the display system uses a single write pointer circuit to track traversal across the array of pixels to update the array of pixels; the series of successive field updates further includes a third field update in which a third write pointer circuit tracks a third traversal, during a third update period, across the array of pixels to update the array of pixels from the third image field to a fourth image field of the image field sequence; the first update period, the second update period, and the third update period are each at least three times the minimum panel update period; the second image field is displayed for a second field duration shorter than the minimum panel update period; the third image field is displayed for a third field duration shorter than the minimum panel update period; and the fourth image field is displayed for a fourth field duration longer than the minimum panel update period, such that a sum of the second field duration, the third field duration, and the fourth field duration is at least three times the minimum panel update period.

Example 16: The method of any of the preceding examples, wherein: the image frame is displayed by using a binary pulse-width modulation (PWM) technique to apply, to the array of pixels, an array of multi-bit brightness values that corresponds to the array of pixels for the image frame; the first image field of the image field sequence includes a first array of binary values forming a first bit plane of the array of multi-bit brightness values; and the second image field of the image field sequence includes a second array of binary values forming a second bit plane of the array of multi-bit brightness values.

Example 17: The method of any of the preceding examples, wherein: the array of pixels is arranged on a display panel with respect to a plurality of display units implemented by one of: single rows on the display panel, multi-row groups on the display panel, or partial rows on the display panel; during the first field update, the first write pointer circuit tracks the plurality of display units, beginning with a first display unit, to update each of the plurality of display units; and the second update period of the second field update begins immediately subsequent to the first display unit being updated.

Example 18: A non-transitory computer-readable medium storing instructions that, when executed, cause a frame controller of a display system to perform a process comprising: causing an array of pixels to display an image frame by performing a series of successive field updates, the series of successive field updates including: a first field update in which a first write pointer circuit tracks a first traversal, during a first update period, across the array of pixels to update the array of pixels from a first image field of an image field sequence to a second image field of the image field sequence, and a second field update in which a second write pointer circuit tracks a second traversal, during a second update period, across the array of pixels to update the array of pixels from the second image field to a third image field of the image field sequence; wherein the second update period of the second field update overlaps the first update period of the first field update.

Example 19: The non-transitory computer-readable medium of any of the preceding examples, wherein: a minimum panel update period is defined as a time period in which the frame controller uses a single write pointer circuit to track traversal across the array of pixels to update the array of pixels; the series of successive field updates further includes a third field update in which a third write pointer circuit tracks a third traversal, during a third update period, across the array of pixels to update the array of pixels from the third image field to a fourth image field of the image field sequence; the first update period, the second update period, and the third update period are each at least three times the minimum panel update period; the second image field is displayed for a second field duration shorter than the minimum panel update period; the third image field is displayed for a third field duration shorter than the minimum panel update period; and the fourth image field is displayed for a fourth field duration longer than the minimum panel update period, such that a sum of the second field duration, the third field duration, and the fourth field duration is at least three times the minimum panel update period.

Example 20: The non-transitory computer-readable medium of any of the preceding examples, wherein: the array of pixels is arranged on a display panel with respect to a plurality of display units implemented by one of: single rows on the display panel, multi-row groups on the display panel, or partial rows on the display panel; during the first field update, the first write pointer circuit tracks the plurality of display units, beginning with a first display unit, to update each of the plurality of display units; and the second update period of the second field update begins immediately subsequent to the first display unit being updated.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. A first element could be termed a second element, and, similarly, a second element could be termed a first element, without departing from the scope of the implementations of the disclosure. As used herein, the term and/or includes any and all combinations of one or more of the associated listed items.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, or location information may be obtained (such as to a city, zip code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A display system comprising:
an array of pixels; and
a frame controller configured to cause the array of pixels to display an image frame by performing a series of successive field updates, the series of successive field updates including:
a first field update in which a first write pointer circuit tracks a first traversal, during a first update period, across the array of pixels to update the array of pixels from a first image field of an image field sequence to a second image field of the image field sequence, and
a second field update in which a second write pointer circuit tracks a second traversal, during a second update period, across the array of pixels to update the array of pixels from the second image field to a third image field of the image field sequence;
wherein the second update period of the second field update overlaps the first update period of the first field update.

2. The display system of claim 1, wherein:
a minimum panel update period is defined as a time period in which the frame controller uses a single write pointer circuit to track traversal across the array of pixels to update the array of pixels;
the first update period and the second update period are each at least twice the minimum panel update period;
the second image field is displayed for a second field duration shorter than the minimum panel update period; and
the third image field is displayed for a third field duration longer than the minimum panel update period, such that a sum of the second field duration and the third field duration is at least twice the minimum panel update period.

3. The display system of claim 1, wherein:
a minimum panel update period is defined as a time period in which the frame controller uses a single write pointer circuit to track traversal across the array of pixels to update the array of pixels;
the series of successive field updates further includes a third field update in which a third write pointer circuit tracks a third traversal, during a third update period, across the array of pixels to update the array of pixels from the third image field to a fourth image field of the image field sequence;
the first update period, the second update period, and the third update period are each at least three times the minimum panel update period;
the second image field is displayed for a second field duration shorter than the minimum panel update period;
the third image field is displayed for a third field duration shorter than the minimum panel update period; and
the fourth image field is displayed for a fourth field duration longer than the minimum panel update period, such that a sum of the second field duration, the third field duration, and the fourth field duration is at least three times the minimum panel update period.

4. The display system of claim 1, wherein the series of successive field updates is performed such that each image field of the image field sequence is displayed for a unique field duration distinct from other field durations of other image fields of the image field sequence.

5. The display system of claim 1, wherein the first image field of the image field sequence includes an array of binary values corresponding to the array of pixels.

6. The display system of claim 1, wherein the first image field of the image field sequence includes an array of multi-bit values corresponding to the array of pixels.

7. The display system of claim 1, wherein:
the image frame is displayed by using a binary pulse-width modulation (PWM) technique to apply, to the array of pixels, an array of multi-bit brightness values that corresponds to the array of pixels for the image frame;
the first image field of the image field sequence includes a first array of binary values forming a first bit plane of the array of multi-bit brightness values; and
the second image field of the image field sequence includes a second array of binary values forming a second bit plane of the array of multi-bit brightness values.

8. The display system of claim 1, wherein:
the array of pixels is arranged in a plurality of rows on a display panel; and
the first traversal and the second traversal across the array of pixels are each performed in a sequential update order that begins with a top row of the plurality of rows and continues sequentially through successive rows until reaching a bottom row of the plurality of rows.

9. The display system of claim 1, wherein:
the array of pixels is arranged in a plurality of rows on a display panel; and
the first traversal and the second traversal across the array of pixels are each performed in a nonsequential update order distinct from a sequential update order that begins with a top row of the plurality of rows and continues sequentially through successive rows until reaching a bottom row of the plurality of rows.

10. The display system of claim 1, wherein:
the array of pixels is arranged on a display panel with respect to a plurality of display units;
during the first field update, the first write pointer circuit tracks the plurality of display units, beginning with a first display unit, to update each of the plurality of display units; and
the second update period of the second field update begins immediately subsequent to the first display unit being updated.

11. The display system of claim 10, wherein the plurality of display units are implemented as single rows on the display panel.

12. The display system of claim 10, wherein the plurality of display units are implemented as multi-row groups on the display panel.

13. The display system of claim 10, wherein the plurality of display units are implemented as partial rows on the display panel.

14. A method comprising:
causing, by a display system, an array of pixels to display an image frame by performing a series of successive field updates, the series of successive field updates including:
a first field update in which a first write pointer circuit tracks a first traversal, during a first update period, across the array of pixels to update the array of pixels from a first image field of an image field sequence to a second image field of the image field sequence, and
a second field update in which a second write pointer circuit tracks a second traversal, during a second update period, across the array of pixels to update the array of pixels from the second image field to a third image field of the image field sequence;
wherein the second update period of the second field update overlaps the first update period of the first field update.

15. The method of claim 14, wherein:
a minimum panel update period is defined as a time period in which the display system uses a single write pointer circuit to track traversal across the array of pixels to update the array of pixels;
the series of successive field updates further includes a third field update in which a third write pointer circuit tracks a third traversal, during a third update period, across the array of pixels to update the array of pixels from the third image field to a fourth image field of the image field sequence;
the first update period, the second update period, and the third update period are each at least three times the minimum panel update period;
the second image field is displayed for a second field duration shorter than the minimum panel update period;
the third image field is displayed for a third field duration shorter than the minimum panel update period; and
the fourth image field is displayed for a fourth field duration longer than the minimum panel update period, such that a sum of the second field duration, the third field duration, and the fourth field duration is at least three times the minimum panel update period.

16. The method of claim 14, wherein:
the image frame is displayed by using a binary pulse-width modulation (PWM) technique to apply, to the array of pixels, an array of multi-bit brightness values that corresponds to the array of pixels for the image frame;
the first image field of the image field sequence includes a first array of binary values forming a first bit plane of the array of multi-bit brightness values; and
the second image field of the image field sequence includes a second array of binary values forming a second bit plane of the array of multi-bit brightness values.

17. The method of claim 14, wherein:
the array of pixels is arranged on a display panel with respect to a plurality of display units implemented by one of:
single rows on the display panel,
multi-row groups on the display panel, or
partial rows on the display panel;
during the first field update, the first write pointer circuit tracks the plurality of display units, beginning with a first display unit, to update each of the plurality of display units; and
the second update period of the second field update begins immediately subsequent to the first display unit being updated.

18. A non-transitory computer-readable medium storing instructions that, when executed, cause a frame controller of a display system to perform a process comprising:
causing an array of pixels to display an image frame by performing a series of successive field updates, the series of successive field updates including:
a first field update in which a first write pointer circuit tracks a first traversal, during a first update period, across the array of pixels to update the array of pixels from a first image field of an image field sequence to a second image field of the image field sequence, and
a second field update in which a second write pointer circuit tracks a second traversal, during a second update period, across the array of pixels to update the array of pixels from the second image field to a third image field of the image field sequence;
wherein the second update period of the second field update overlaps the first update period of the first field update.

19. The non-transitory computer-readable medium of claim 18, wherein:
a minimum panel update period is defined as a time period in which the frame controller uses a single write pointer circuit to track traversal across the array of pixels to update the array of pixels;
the series of successive field updates further includes a third field update in which a third write pointer circuit tracks a third traversal, during a third update period, across the array of pixels to update the array of pixels from the third image field to a fourth image field of the image field sequence;
the first update period, the second update period, and the third update period are each at least three times the minimum panel update period;
the second image field is displayed for a second field duration shorter than the minimum panel update period;
the third image field is displayed for a third field duration shorter than the minimum panel update period; and
the fourth image field is displayed for a fourth field duration longer than the minimum panel update period, such that a sum of the second field duration, the third field duration, and the fourth field duration is at least three times the minimum panel update period.

20. The non-transitory computer-readable medium of claim 18, wherein:
the array of pixels is arranged on a display panel with respect to a plurality of display units implemented by one of:
single rows on the display panel,
multi-row groups on the display panel, or
partial rows on the display panel;
during the first field update, the first write pointer circuit tracks the plurality of display units, beginning with a first display unit, to update each of the plurality of display units; and
the second update period of the second field update begins immediately subsequent to the first display unit being updated.
